(19) United States
(12) Patent Application Publication
(10) Pub. No.: US 2017/0087711 A1
(43) Pub. Date: Mar. 30, 2017

(54) Board Shaping Support and Tool Chest

(71) Applicant: James Furlong, Grovetown, GA (US)

(72) Inventor: James Furlong, Grovetown, GA (US)

(21) Appl. No.: 15/279,827

(22) Filed: Sep. 29, 2016

Related U.S. Application Data
(60) Provisional application No. 62/235,027, filed on Sep. 30, 2015.

(51) Int. Cl. B25H 1/12; B25H 7/02; B25H 1/04

(52) U.S. Cl. CPC B25H 1/12; B25H 1/04; B25H 7/02

(57) ABSTRACT

A board shaping support and tool chest allows for the storage, transportation, and mounting of wood shaping tools. The board shaping support and tool chest includes an elongated block with a first storage compartment and a second storage compartment to house tools and materials. A first guide lid and a second guide lid retain the contents of the first storage compartment and the second storage compartment during transportation, as well as support a board to be cut or shaped. A shaping tool, such as a miter saw, drop saw, circular saw or router, is positioned between the first guide lid and the second guide lid during implementation. The board shaping support and tool chest further includes a first guide support and a second guide support to align the board to the fence of a miter or drop saw and prevent the board from kicking out from the saw blade rotation.

The current application claims a priority to the U.S. Provisional Patent application Ser. No. 62/235,027 filed on Sep. 30, 2015.

### FIELD OF THE INVENTION

The present invention relates generally to a workbench for supporting shaping machines. More specifically, the present invention is a board shaping support and tool chest combination to house tools and provide a stable workstation for cutting and shaping building materials.

### BACKGROUND OF THE INVENTION

Portable workbenches are typically necessary for construction, renovation, or hobby jobs in order for a contractor or home owner to conveniently mount tools such as miter saws and drop saws. These workbenches additionally provide support for boards to be shaped with routers, jig saws, and circular saws. The portability of these workbenches allow for the workbenches to be stored and transported effectively. Current portable workbenches include a bench on a scissor lift, however, these benches lack casters resulting in these benches being cumbersome to move. Other workbenches can be constructed from two saw horses for support and a sheet of plywood to provide a work surface in short notice from materials found onsite. These workbench options, however, do not allow a user to store tools with the bench to be transported at the same time.

The present invention is a board shaping support and tool bench. The present invention allows the user to store tools or materials within the present invention. The present invention further allows a base for a miter saw or drop saw to be mounted flush with a pair of guide lids in order to provide a level surface for a board to rest on to be cut. The guiding lids includes incremented markings to measure the board to allow the board to be cut to specific lengths. Further, the present invention includes a plurality of light sources to allow the user to use the present invention in unfavorable lighting conditions.

### BRIEF DESCRIPTION OF THE DRAWINGS

FIG. 1 is a top perspective view of the present invention, wherein the first guide lid and the second guide lid are closed against the top mounting face.

FIG. 2 is an alternate top perspective view of the present invention with the first guide lid and the second guide lid are open from the top mounting face.

FIG. 3 is a front view of the present invention, wherein the first guide lid and the second guide lid are closed against the top mounting face.

FIG. 4 is a top view of the present invention, wherein the first guide lid and the second guide lid are closed against the top mounting face.

FIG. 5 is a left view of the present invention, wherein the first guide lid and the second guide lid are closed against the top mounting face.

FIG. 6 is a right view of the present invention, wherein the first guide lid and the second guide lid are closed against the top mounting face.

FIG. 7 is a bottom perspective view of the present invention, wherein the first guide lid and the second guide lid are positioned away from the top mounting face.

FIG. 8 is a top perspective view of the present invention, wherein the first guide lid and the second guide lid are closed against the top mounting face and wherein the second guide lid is translucent.

FIG. 9 is a front cross-sectional view of the present invention taken along line 9-9 of FIG. 4.

### DETAIL DESCRIPTIONS OF THE INVENTION

All illustrations of the drawings are for the purpose of describing selected versions of the present invention and are not intended to limit the scope of the present invention.

The present invention is a board shaping support and tool chest. The present invention provides a container for transporting tools and materials; however, more importantly, the present invention allows a miter saw, drop saw, or similar devices to be mounted flush with a surface of the present invention in order to support a board along its length for cutting. The supporting surface includes incremental markers in order to allow the user to quickly measure the length of the board to be cut to specification simply.

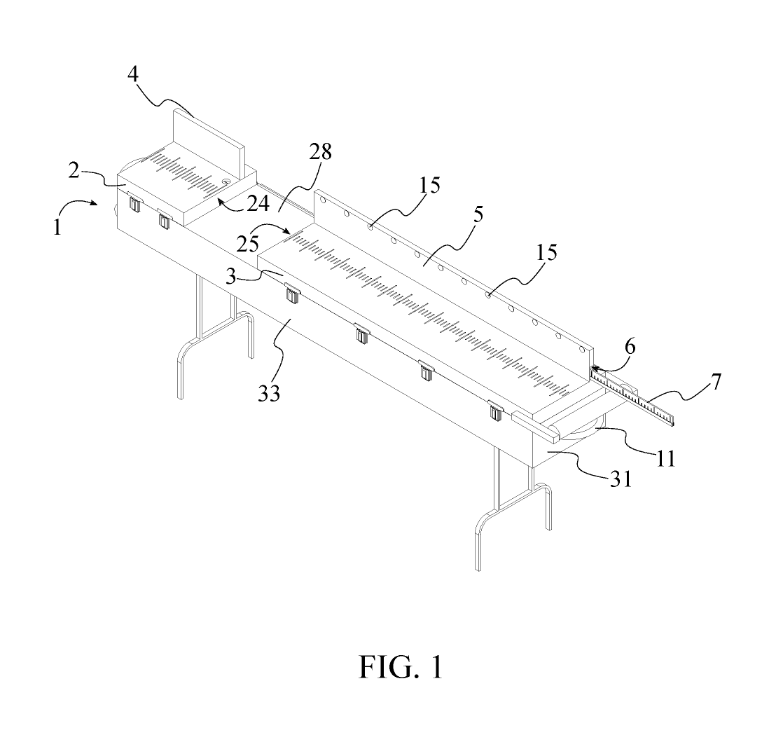

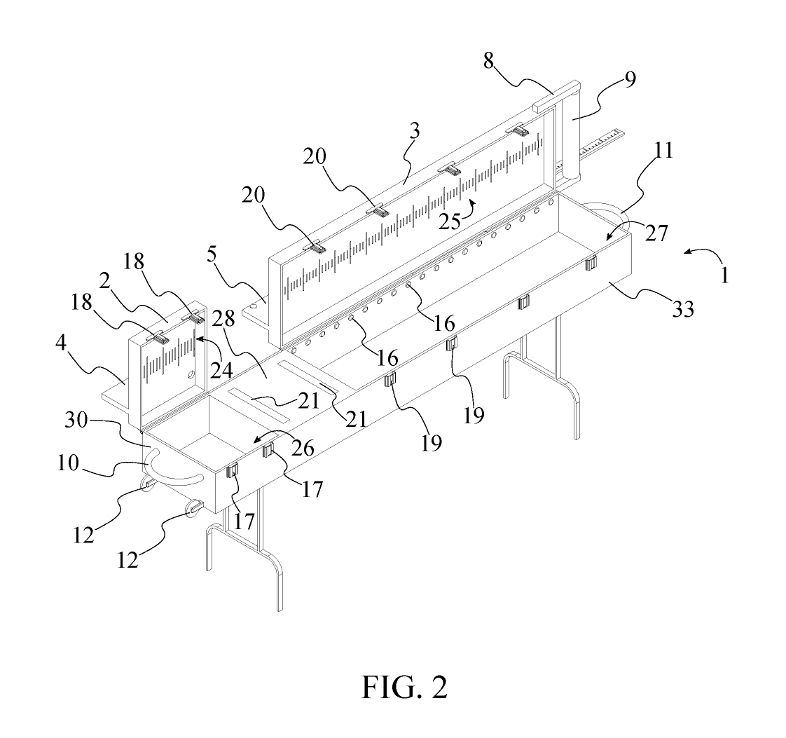

In accordance to FIG. 1 and FIG. 2, the present invention comprises an elongated block 1, a first guide lid 2, and a second guide lid 3. The elongated block 1 provides support for board shaping tools, such as a miter saw or drop saw. The elongated block 1 comprises a first storage compartment 26 and a second storage compartment 27 and a top mounting face 28, as detailed in FIG. 2. The first storage compartment 26 and the second storage compartment 27 traverse into the top mounting face 28 in order to provide storage space for tools or materials. The first storage compartment 26 and the second storage compartment 27 are offset from each other along the top mounting face 28. This offset allows for a shaping tool to be implemented between the first guide lid 2 and the second guide lid 3. The first guide lid 2 is hingedly connected to the elongated block 1 adjacent to the first storage compartment 26. The second guide lid 3 is hingedly connected to the elongated block 1 adjacent to the second storage compartment 27. A support surface for each of the first guide lid 2 and the second guide lid 3 is offset from the elongated block 1 in order for the support surface to be flush with the base of a miter saw, drop saw or similar tools. This allows a board to be supported along its length between the first guide lid 2, the mounted shaping tool, and the second guide lid 3 to prevent bowing of the board while the board is being cut.

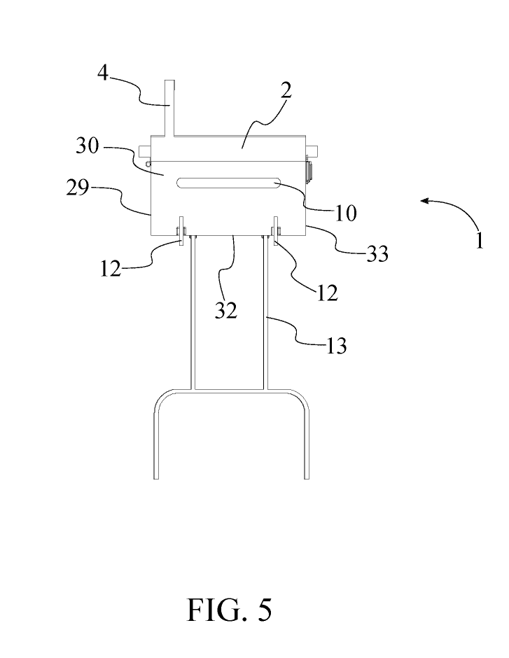

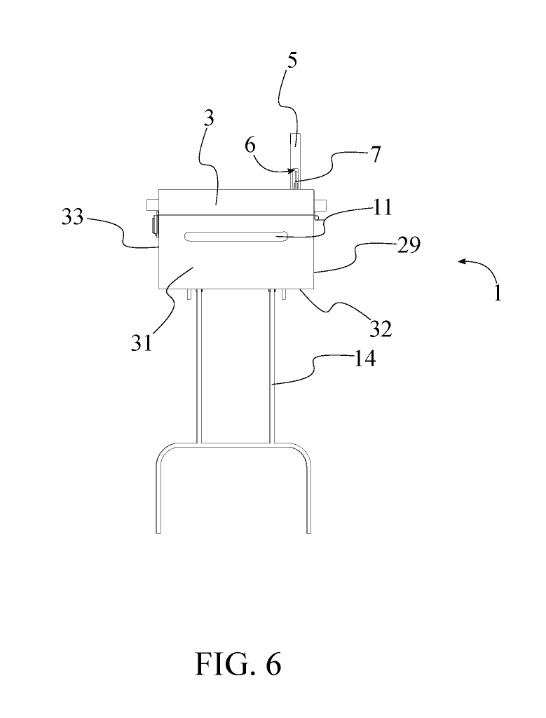

More specifically, the elongated block 1 comprises a rear lateral face 29 for the positioning of the hinged connection of the first guide lid 2 and the second guide lid 3, in accordance to FIG. 5 and FIG. 6. The first guide lid 2 is hingedly connected to the elongated block 1, adjacent to the rear lateral face 29, as shown in FIG. 5. Similarly, the second guide lid 3 is hingedly connected to the elongated block 1, adjacent to the rear lateral face 29, as shown in FIG. 6. Thus, the first guide lid 2 and the second guide lid 3 are able to be lifted from the front of the present invention during implementation in order to access the first storage compartment 26 and the second storage compartment 27, respectively.

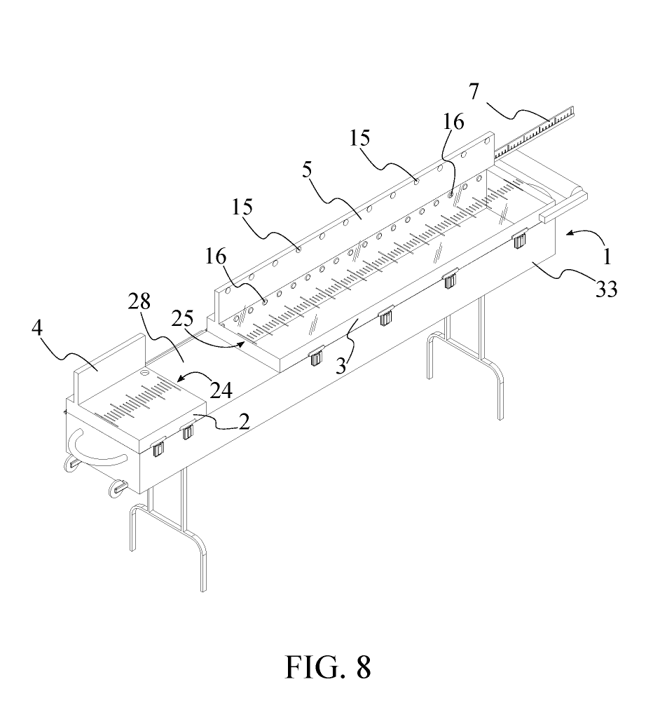

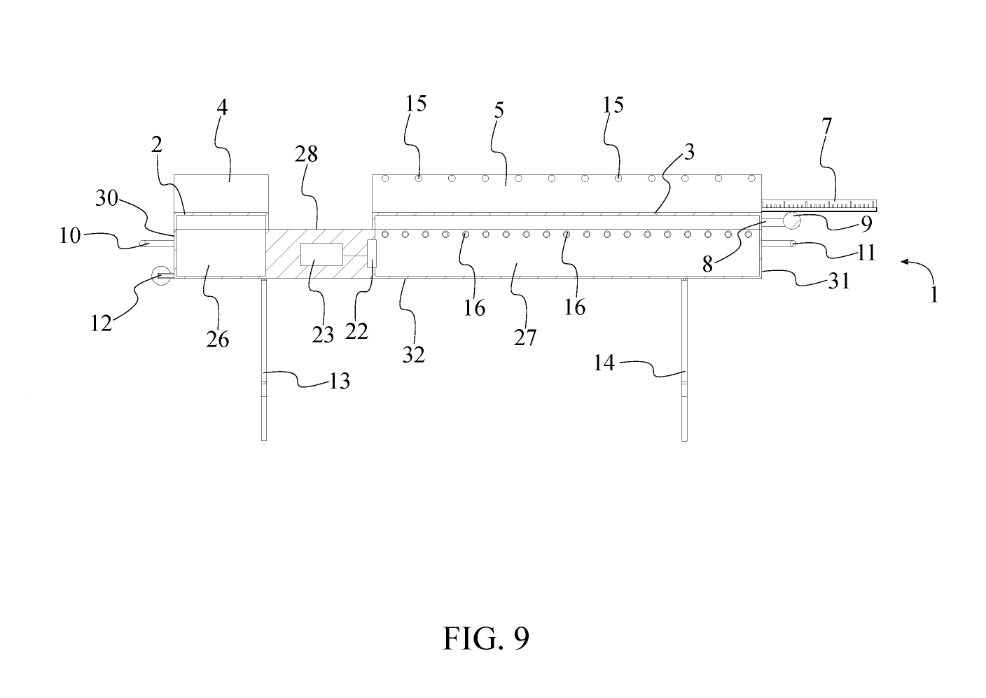

In accordance to the preferred embodiment of the present invention, the present invention comprises a first guide support 4 and a second guide support 5, as detailed in FIG. 1 to FIG. 6, FIG. 8 and FIG. 9. The first guide support 4 prevents the board from being ejected by a miter saw or drop saw from the rotation of the sawblade. The first guide support 4 is adjacently connected along the first guide lid 2. The first guide support 4 is positioned opposite to the top mounting face 28 about the first guide lid 2, in order to allow a board to be pressed against the first guide support 4 as the first guide lid 2 is positioned adjacent to the top mounting face 28. The first guide support 4 is offset from the hinged connection between the elongated block 1 and the first guide lid 2, such that the first guide support 4 aligns to a fence of the shaping tool. The first guide support 4 is oriented perpendicular to the first guide lid 2. Similarly, the second guide support 5 prevents the board from being ejected by a miter saw or drop saw from the rotation of the sawblade from the opposite side of the sawblade from the first guide support 4. The second guide support 5 is adjacently connected along the second guide lid 3. The second guide support 5 is positioned opposite to the top mounting face 28 about the second guide lid 3, in order to allow a board to be pressed against the second guide support 5 as the second guide lid 3 is positioned adjacent to the top mounting face 28. The second guide support 5 is offset from the hinged connection between the elongated block 1 and the second guide lid 3, such that the first guide support 4 aligns to a fence of the shaping tool. The second guide support 5 is oriented perpendicular to the second guide lid 3. This configuration allows the user to press a board to be pressed against the first guide support 4 and the second guide support 5 when the board is to be shaped in order to allow for consistent manipulation of the board.

In some embodiments of the present invention, the present invention comprises a ruler-receiving hole 6 and an extendable ruler 7, in accordance to FIG. 1 and FIG. 6. The ruler-receiving hole 6 houses the extendable ruler 7 for storage and transportation. The ruler-receiving hole 6 traverses into the second guide support 5, opposite to the first guide lid 2. The ruler-receiving hole 6 is adjacently positioned to the second guide lid 3. The ruler-receiving hole 6 is oriented parallel to the hinged connection between the elongated block 1 and the second guide lid 3 in order to receive the extendable ruler 7 along the length of the second guide support 5. The extendable ruler 7 allows the user to accurately measure the length of the board from the cutting tool to the opposite end of the board, if the length of board exceeds the length from the cutting tool to an end of elongated block 1 opposite the cutting tool along the second storage compartment 27. The extendable ruler 7 is slideably engaged with the ruler-receiving hole 6, in order to allow the extendable ruler 7 to be extracted from the second guide support 5 to increase the measurable length for a board or inserted into the second guide support 5 for storage and transportation with the elongated block 1.

In addition to the extendable ruler 7, some embodiments of the present invention comprise an extendable bracket 8 and a rolling support 9, as shown in FIG. 1, FIG. 2 and FIG. 6. The extendable bracket 8 allows the rolling support 9 to extend away from or retract to the second guide lid 3. The rolling support 9 supports the length of a board that extends past the elongated block 1. The extendable bracket 8 is slideably integrated into the second guide lid 3. The extendable bracket 8 is oriented away from the first guide lid 2. The rolling support 9 is rotatably and terminally connected to the extendable bracket 8 opposite to the second guide lid 3. The rolling support 9 allows the excess length of the board past the elongated block 1 to be supported such that the board is able to slide over the rolling support 9 and reduces the force the user needs to exert on the board to slide the board over the second guide lid 3.

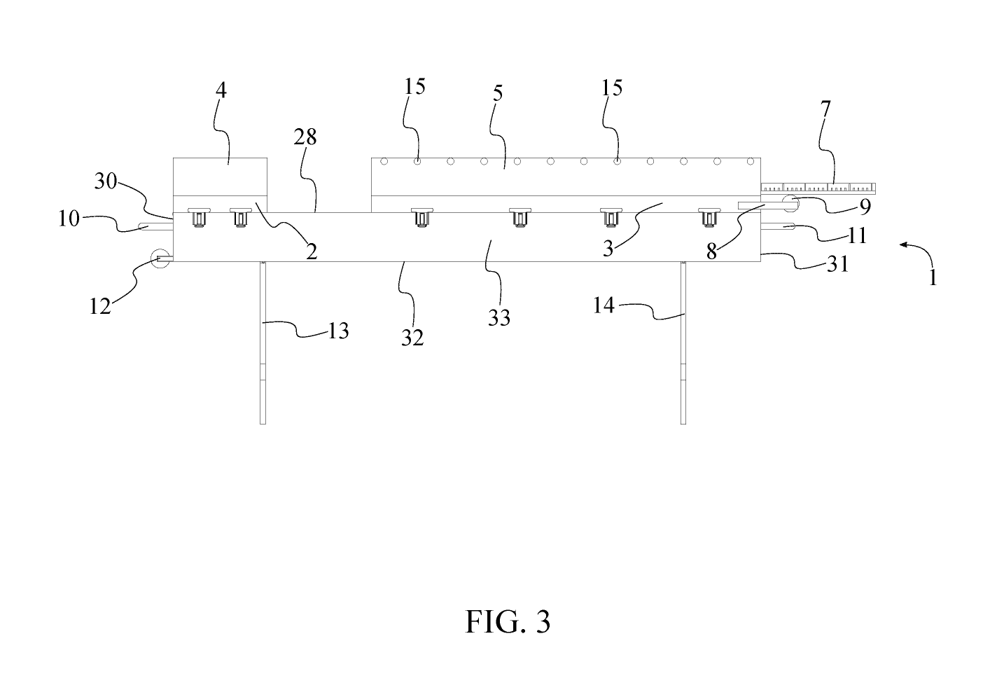

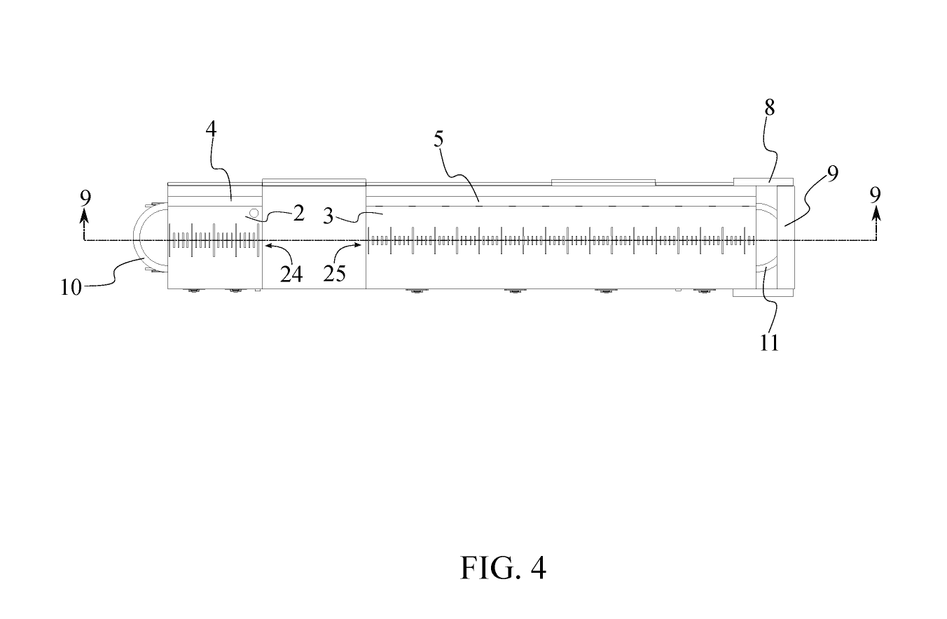

Further in accordance to the preferred embodiment, the present invention comprises a first handle 10 and a second handle 11 and the elongated block 1 comprises a first lateral face 30 and a second lateral face 31. The first handle 10 and the second handle 11 allow the user to grip the present invention in order to lift, push, or relocate the present invention. The first lateral face 30 and the second lateral face 31 are opposite to each other along the elongated block 1, as shown in FIG. 3 and FIG. 4. The first handle 10 is adjacently connected to the first lateral face 30. The first handle 10 is centrally positioned on the first lateral face 30, in accordance to FIG. 5. Similarly, the second handle 11 is adjacently connected to the second lateral face 31, in accordance to FIG. 5. The second handle 11 is centrally positioned on the second lateral face 31. The position for the first handle 10 and the second handle 11 allow the user to distribute the weight of the elongated block 1 and the contents as a lifting force is applied to the first handle 10 and the second handle 11.

In some embodiments of the present invention, the present invention comprises a pair of casters 12, as detailed in FIG. 2 and FIG. 5. The pair of casters 12 allows the present invention to be rolled along a ground surface, reducing the effort needed to be exerted by the user to move the present invention. The pair of casters 12 is adjacently connected to the first lateral face 30. The pair of casters 12 is positioned opposite to the top mounting face 28, across the first lateral face 30, such that the contents of the elongated block 1 are maintained as the elongated block 1 is tilted onto the pair of casters 12 for transport. The pair of casters 12 is offset from each other across the first lateral surface. This configuration allows the user to support the elongated block 1 and the contents on the pair of casters 12 as the user pulls or pushes the present invention, such that the user is able to roll the present invention along the ground surface.

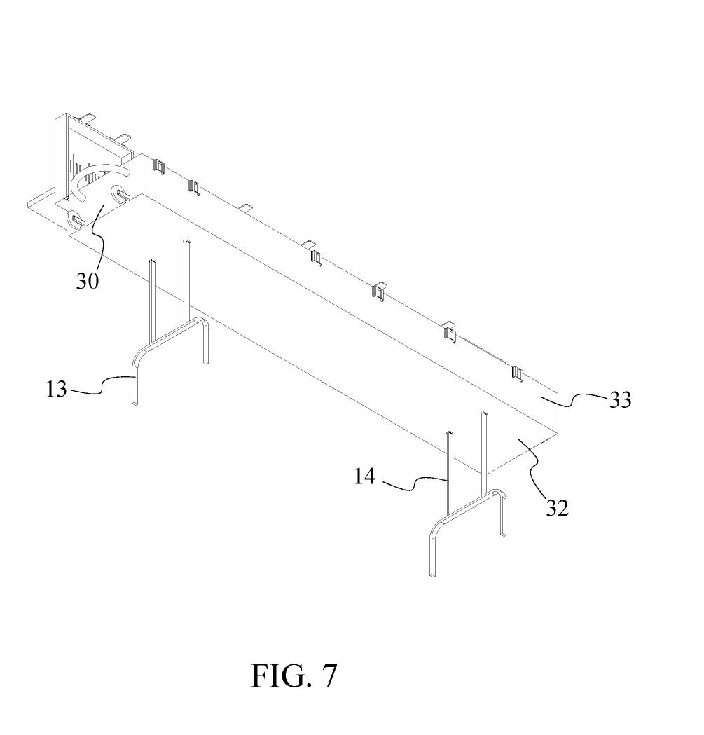

In accordance to the preferred embodiment, the present invention further comprises a first pair of supporting legs 13 and a second pair of supporting legs 14, and the elongated block 1 comprises a base surface 32, as shown in FIG. 3 and FIG. 7. The first pair of supporting legs 13 and the second pair of supporting legs 14 allow the elongated block 1 to be offset from a ground surface, in order for the top mounting face 28 to be conveniently positioned for a standing user. The base surface 32 is opposite to the top mounting face 28 about the elongated block 1. The first pair of supporting legs 13 and the second pair of supporting legs 14 are hingedly connected to the base surface 32. The first pair of supporting legs 13 and the second pair of supporting legs 14 are offset from each other, across the base surface 32, in order to allow the first pair of supporting legs 13 and the second pair of supporting legs 14 to be folded flush against the elongated block 1 for storage or transportation of the present invention.

Further in accordance to the preferred embodiment, the present invention comprises a first plurality of catches 17 and a first plurality of latches 18, in order to secure the first guide lid 2 to the elongated block 1 about the first storage compartment 26, and the elongated block 1 comprises a front lateral face 33. As shown in FIG. 2, the first plurality of catches 17 is adjacently connected to the front lateral face 33. The first plurality of catches 17 is adjacently positioned to the top mounting face 28. The first plurality of latches 18 is adjacently connected to the first guide lid 2. The first plurality of latches 18 is positioned opposite to the hinged connection between the elongated block 1 and the first guide lid 2. Each of first plurality of latches 18 engages a corresponding catch of the first plurality of latches 18, therefore, securing the first guide lid 2 to the top mounting face 28, in order to prevent the contents of the first storage compartment 26 from being ejected from the first storage compartment 26 during transportation of the present invention.

Similarly, the present invention comprises a second plurality of catches 19 and a second plurality of latches 20, in order to secure the second guide lid 3 to the elongated block 1 about the second storage compartment 27, and the elongated block 1 comprises a front lateral face 33. As shown in FIG. 2, the second plurality of catches 19 is adjacently connected to the front lateral face 33. The second plurality of catches 19 is adjacently positioned to the top mounting face 28. The second plurality of latches 20 is adjacently connected to the second guide lid 3. The second plurality of latches 20 is positioned opposite to the hinged connection between the elongated block 1 and the second guide lid 3. Each of second plurality of latches 20 engages a corresponding catch of the second plurality of latches 20, therefore, securing the second guide lid 3 to the top mounting face 28, in order to prevent the contents of the second storage compartment 27 from being ejected from the second storage compartment 27 during transportation of the present invention.

In some embodiments of the present invention, the present invention comprises a pair of quick-release mechanisms 21, in accordance to FIG. 2. The pair of quick-release mechanisms 21 allows the user to easily attach and detach shaping machine, such as a miter saw or a drop saw, to the top mounting face 28, and the pair of quick-release mechanisms 21 secures the shaping machine from sliding as the shaping machine is used. The pair of quick-release mechanisms 21 include, but are not limited to, clamps, threaded protrusions with engaging handles, removable bolt with a securing nut, or a similar mechanism to quickly fasten the base of a shaping tool to the top mounting face 28. The pair of quick-release mechanisms 21 is integrated into the top mounting face 28, between the first storage compartment 26 and the second storage compartment 27, in order to engage the base of the shaping machine.

In another embodiment of the present invention, the present invention comprises an electrical outlet 22 and an electrical junction box 23, in accordance to FIG. 9. The electrical outlet 22 connects a shaping machine to an external power source in order to provide power to the shaping machine to function. The electrical junction box 23 connects directly to the external power source to provide power to the electrical outlet 22 and other electrical devices integrated into the present invention. The electrical outlet 22 is integrated into the second storage compartment 27. The electrical outlet 22 is adjacently positioned to the first storage compartment 26, such that shaping machinery is able to easily engage the electrical outlet 22 as the shaping machinery is mounted onto the top mounting face 28 between the first storage compartment 26 and the second storage compartment 27. The electrical junction box 23 is mounted within the elongated block 1, and the electrical junction box 23 is positioned between the first storage compartment 26 and the second storage compartment 27, in order to maximize the storage volume within the first storage compartment 26 and the second storage compartment 27. The electrical junction box 23 is electrically connected to an external power source. The electrical outlet 22 is electrically connected to the electrical junction box 23 in order to direct electricity from the external power source to a shaping machine.

Further in accordance to the present invention, the present invention comprises a first plurality of incremental markings 24, as shown in FIG. 1, FIG. 2, FIG. 4 and FIG. 8. The first plurality of incremental markings 24 is a set of labels to indicate length along the first guide lid 2 to measure the board to be cut to a specific length. The first plurality of incremental markings 24 is superimposed onto the first guide lid 2. The first plurality of incremental markings 24 is centrally positioned across the first guide lid 2, and the first plurality of incremental markings 24 is evenly distributed along the first guide lid 2. This configuration allows the user vision of the first plurality of incremental markings 24 as a board is pressed against the first guide support 4 in order to position the board to a specific length for cutting or shaping.

Similarly, the present invention is preferred to comprise a second plurality of incremental markings 25, as shown in FIG. 1, FIG. 2, FIG. 4 and FIG. 8. The second plurality of incremental markings 25 is a set of labels to indicate length along the second guide lid 3 to measure the board to be cut to a specific length. The second plurality of incremental markings 25 is superimposed onto the second guide lid 3. The second plurality of incremental markings 25 is centrally positioned across the second guide lid 3, and the second plurality of incremental markings 25 is evenly distributed along the second guide lid 3. This configuration allows the user vision of the second plurality of incremental markings 25 as a board is pressed against the second guide support 5 in order to position the board to a specific length for cutting or shaping.

In some embodiments of the present invention, the present invention comprises a first plurality of light sources 15 to illuminate the first plurality of incremental markings 24 and the second guide lid 3, in order to provide a working surface in low-light conditions. As detailed in FIG. 1 to FIG. 3, FIG. 8 and FIG. 9, the first plurality of light sources 15 is integrated into the second guide support 5. The first plurality of light sources 15 is evenly distributed along the second guide support 5. The first plurality of light sources 15 is positioned opposite to the second guide lid 3 across the second guide support 5 in order to prevent obstruction of pressing a board against the second guide support 5 the present invention from the first plurality of light sources 15. The first plurality of light sources 15 is oriented toward the second guide lid 3 in order to illuminate the second guide lid 3 and the second plurality of incremental markings 25, more specifically.

In some embodiments of the present invention, the present invention comprises a second plurality of light sources 16 to illuminate the second plurality of incremental markings 25 and the second guide lid 3 from below the second guide lid 3, in order to provide a working surface in unfavorable lighting conditions. As shown in FIG. 2, FIG. 8, and FIG. 9, the second plurality of light sources 16 is integrated into the second storage compartment 27. The second plurality of light sources 16 is evenly distributed along the second storage compartment 27. The second plurality of light sources 16 is adjacently positioned to the hinged connection between the elongated block 1 and the second guide lid 3 in order to prevent obstruction of pressing a board against the second guide lid 3 from the second plurality of light sources 16. The second plurality of light sources 16 is oriented toward the second guide lid 3 in order to illuminate the second guide lid 3 and the second plurality of incremental markings 25, more specifically. The second guide lid 3 for these embodiments is preferred to be translucent in order to allow the second plurality of light sources 16 to illuminate the second incremental markings from within the second storage compartment 27.

Although the invention has been explained in relation to its preferred embodiment, it is to be understood that many other possible modifications and variations can be made without departing from the spirit and scope of the invention as hereinafter claimed.

What is claimed is:

1. A board shaping support and tool chest comprises:
an elongated block;
a first guide lid;
a second guide lid;
the elongated block comprises a first storage compartment, a second storage compartment, and a top mounting face;
the first storage compartment and the second storage compartment traversing into the top mounting face;
the first storage compartment and the second storage compartment being offset from each other, along the top mounting face;
the first guide lid being hingedly connected to the elongated block, adjacent to the first storage compartment; and
the second guide lid being hingedly connected to the elongated block, adjacent to the second storage compartment.

2. The board shaping support and tool chest, as claimed in claim 1, comprises:
the elongated block comprises a rear lateral face;
the first guide lid being hingedly connected to the elongated block, adjacent to the rear lateral face; and
the second guide lid being hingedly connected to the elongated block, adjacent to the rear lateral face.

3. The board shaping support and tool chest, as claimed in claim 1, comprises:
a first guide support;
the first guide support being adjacently connected along the first guide lid;
the first guide support being positioned opposite to the top mounting face about the first guide lid; and
the first guide support being oriented perpendicular to the first guide lid.

4. The board shaping support and tool chest, as claimed in claim 3, comprises:
the first guide support being offset from the hinged connection between the elongated block and the first guide lid.

5. The board shaping support and tool chest, as claimed in claim 1, comprises:
a second guide support;
the second guide support being adjacently connected along the second guide lid;
the second guide support being positioned opposite to the top mounting face about the second guide lid; and
the second guide support being oriented perpendicular to the second guide lid.

6. The board shaping support and tool chest, as claimed in claim 5, comprises:
the second guide support being offset from to the hinged connection between the elongated block and the second guide lid;

7. The board shaping support and tool chest, as claimed in claim 5, comprises:
a first plurality of light sources;
the first plurality of light sources being integrated into the second guide support;
the first plurality of light sources being evenly distributed along the second guide support;
the first plurality of light sources being positioned opposite to the second guide lid across the second guide support; and
the first plurality of light sources being oriented towards the second guide lid.

8. The board shaping support and tool chest, as claimed in claim 5, comprises:
a ruler-receiving hole;
an extendable ruler;
the ruler-receiving hole traversing into the second guide support, opposite to the first guide lid;
the ruler-receiving hole being adjacently positioned to the second guide lid;
the ruler-receiving hole being oriented parallel to the hinged connection between the elongated block and the second guide lid; and
the extendable ruler being slideably engaged with the ruler-receiving hole.

9. The board shaping support and tool chest, as claimed in claim 1, comprises:
an extendable bracket;
a rolling support;
the extendable bracket being slideably integrated into the second guide lid;
the extendable bracket being oriented away from the first guide lid; and
the rolling support being rotatably and terminally connected to the extendable bracket, opposite to the second guide lid.

10. The board shaping support and tool chest, as claimed in claim 1, comprises:
a first handle;
a second handle;
the elongated block comprises a first lateral face and a second lateral face;
the first lateral face and the second lateral face being opposite to each other along the elongated block;
the first handle being adjacently connected to the first lateral face;
the first handle being centrally positioned on the first lateral face;
the second handle being adjacently connected to the second lateral face; and
the second handle being centrally positioned on the second lateral face.

11. The board shaping support and tool chest, as claimed in claim 1, comprises:
a pair of casters;
the elongated block comprises a first lateral face;
the pair of casters being adjacently connected to the first lateral face;
the pair of casters being positioned opposite to the top mounting face, across the first lateral face; and
the pair of casters being offset from each other across the first lateral face.

12. The board shaping support and tool chest, as claimed in claim 1, comprises:
a first pair of supporting legs;
a second pair of supporting legs;
the elongated block further comprises a base surface;
the base surface being opposite to the top mounting face about the elongated block;
the first pair of supporting legs and the second pair of supporting legs being hingedly connected to the base surface; and
the first pair of supporting legs and the second pair of supporting legs being offset from each other, across to the base surface.

13. The board shaping support and tool chest, as claimed in claim 1, comprises:
wherein the second guide lid is translucent;
a second plurality of light sources;
the second plurality of light sources being integrated into the second storage compartment;
the second plurality of light sources being evenly distributed along the second storage compartment;
the second plurality of light sources being adjacently positioned to the hinged connection between the elongated block and the second guide lid; and
the second plurality of light sources being oriented towards the second guide lid.

14. The board shaping support and tool chest, as claimed in claim 1, comprises:
a first plurality of catches;
a first plurality of latches;
the elongated block comprises a front lateral face;
the first plurality of catches being adjacently connected to the front lateral face;
the first plurality of catches being adjacently positioned to the first storage compartment;
the first plurality of latches being adjacently connected to the first guide lid;
the first plurality of latches being positioned opposite to the hinged connection between the elongated block and the first guide lid; and
each of first plurality of latches selectively engaging a corresponding catch of the first plurality of catches.

15. The board shaping support and tool chest, as claimed in claim 1, comprises:
a second plurality of catches;
a second plurality of latches;
the elongated block comprises a front lateral face;
the second plurality of catches being adjacently connected to the front lateral face;
the second plurality of catches being adjacently positioned to the second storage compartment;
the second plurality of latches being adjacently connected to the second guide lid;
the second plurality of latches being positioned opposite to the hinged connection between the elongated block and the second guide lid; and
each of second plurality of latches selectively engaging a corresponding catch of the second plurality of catches.

16. The board shaping support and tool chest, as claimed in claim 1, comprises:
a pair of quick-release mechanisms; and
the pair of quick-release mechanism being integrated into the top mounting face between the first storage compartment and the second storage compartment.

17. The board shaping support and tool chest, as claimed in claim 1, comprises:
an electrical outlet;
an electrical junction box;
the electrical outlet being integrated into the second storage compartment;
the electrical outlet being adjacently positioned to the first storage compartment;
the electrical junction box being mounted within the elongated block;
the electrical junction box being positioned between the first storage compartment and the second storage compartment; and
the electrical outlet being electrically connected to the electrical junction box.

18. The board shaping support and tool chest, as claimed in claim 1, comprises:
a first plurality of incremental markings;
the first plurality of incremental markings being superimposed onto the first guide lid;
the first plurality of incremental marking being centrally positioned across the first guide lid; and
the first plurality of incremental markings being evenly distributed along the first guide lid.

19. The board shaping support and tool chest, as claimed in claim 1, comprises:
a second plurality of incremental markings;
the second plurality of incremental markings being superimposed onto the second guide lid;
the second plurality of incremental marking being centrally positioned across the second guide lid; and
the second plurality of incremental markings being evenly distributed along the second guide lid.
